(19) United States
(12) Patent Application Publication
(10) Pub. No.: US 2003/0236749 A1
(43) Pub. Date: Dec. 25, 2003

(54) Automated lottery system and method using ATM network

(76) Inventor: Edward Anthony Shergalis, New York, NY (US)

Correspondence Address: Charles E. Temko, 22 Marion Road, Westport, CT, 06880, US

(21) Appl. No.: 10/176,119

(22) Filed: Jun. 21, 2002

(51) Int. Cl. G06F 17/60

(52) U.S. Cl. 705/43

(57) ABSTRACT

A method of processing lottery ticket purchases using an automated teller machine and automated network to communicate user inserted information for transmission to a transaction processor before transferring to a user bank and a teller machine bank.

### BACKGROUND OF THE PRESENT INVENTION

Numerous processes and devices exist for facilitating electronic payments. Today, virtually all domestic banking institutions offer customers the ability to conduct a limited number of electronic transactions either from an automated teller machine (ATM) located on-site at the institution, or from a remote ATM serving the institution. The remote services are made possible in part through the development of communications systems that provide for the interconnection of many clearinghouse or regional, national, or international electronic funds transfer (EFT) networks. These networks are specialized digital packet networks that communicate with various ATM transaction processors and service providers using standard message protocols. A more-or-less standard, generic ATM interface has developed in the banking industry, making it relatively easy for a consumer to use any ATM on any ATM network once he has learned how to interact with this more-or-less standard interface. Of course, ATMs produced by different manufacturers may differ in key placement, number of keys, key legends, screen size, etc. However, there has been a trend toward standardization of these features so as to minimize user discomfort with using a “foreign bank” ATM.

### SUMMARY OF THE INVENTION

In view of the foregoing, it is an object of the present invention to provide a system and method for automated lottery ticket purchases through the use of ACH debiting and crediting of various payor and payee accounts.

It is yet another object of the present invention to provide a system and method for automated lottery ticket purchases wherein individual consumers can, if desired, purchase lottery tickets at an ATM.

It is a still further object of the present invention to provide a system and method for automated lottery ticket purchases that uses an established ATM network to receive information from a consumer sufficient to validate the consumer payment data and lottery ticket purchase data.

It is a still further object of the present invention to provide a system and method for automated lottery ticket purchase that interfaces between existing ATM networks and lottery game servicer systems to facilitate the purchase of lottery tickets by a consumer through the use of the ATM network.

It is yet another object of the present invention to provide a system and method for automated lottery ticket purchases that operates to convert transaction information between formats used by various lottery game servicers and a format used by an ATM network.

It is also an object of the present invention to reduce payment processing costs for lottery game servicers through the use of ACH debiting and crediting of various payee and payor accounts involved.

Yet a further object of the present invention is to make the lottery ticket purchase process easier and more efficient for the consumer to purchase lottery tickets directly from lottery ticket vendors.

Another object of the invention is to eliminate costs for the servicer related to the maintenance and servicing of lottery ticket vending machines (i.e., paper and ink for printing lottery tickets,).

A further object of the invention is to facilitate any reconciling and reporting that the lottery game servicer must perform by reducing human intervention in lottery ticket vending processes and therefore reducing human error.

### BRIEF DESCRIPTION OF THE DRAWINGS

FIG. 1 shows a block diagram of a conventional ATM system illustrating the transactions that occur during a typical ATM transaction.

FIG. 2 shows a block diagram of the present invention illustrating the transactions that occur during the purchase of a lottery ticket in accordance with the present invention.

FIG. 3 is a flowchart illustrating the process of a lottery ticket purchase using a system of the present invention as shown in FIG. 2.

FIG. 4 is a flowchart of a process used by a 3^{rd} party lottery ticket purchase facilitator to retrieve and process information for forwarding to a lottery game servicer.

FIG. 5 is a flowchart of a process used by a 3rd party lottery ticket purchase facilitator to extract and process lottery ticket purchase data from one or more lottery game servicers in accordance with the present invention.

FIG. 6 is a flowchart of a process used by a third party lottery ticket purchase facilitator to receive and process transaction information from an ATM transactions processor in accordance with the present invention.

FIG. 7 is a flowchart of a process used by a lottery game servicer to receive and process transaction data from a 3rd party lottery ticket purchase facilitator.

### ABSTRACT OF THE DISCLOSURE

An electronic transfer methodology for providing access to online lottery games through established ATMs (automated teller machines) and ATM networks, thereby creating a purchase and ticketing system designed to allow a consumer to purchase a lottery ticket and receive a printed ticket. Automated purchase and ticket printing through use of an ATM and ATM network is facilitated by a processor and associated software, which are employed to combine specific consumer payment data with specific lottery ticket purchase data through an electronic ATM and ATM network for the purpose of affecting a more efficient lottery ticket purchasing process. Information relevant to the lottery ticket purchase is electronically communicated from the ATM through software designed to communicate this information to a third party central computer. The third party central computer reformats the data as necessary, aggregates the relevant consumer payment data associated with the specific lottery ticket purchase data, and transmits the aggregate information to one or more ATM transaction processors and one or more lottery game servicers.

### DETAILED DESCRIPTION OF THE PREFERRED EMBODIMENTS OVERVIEW

The present invention provides an automated lottery ticket purchase system and method for providing access to online lottery games through established ATMs (automated teller machines) and ATM networks, thereby creating a purchase and ticketing system designed to allow a consumer to purchase a lottery ticket and receive a printed ticket. Automated purchase and ticket printing through use of an ATM and ATM network is facilitated by a processor and associated software, which are employed to combine specific consumer payment data with specific lottery ticket purchase data through an electronic ATM and ATM network for the purpose of affecting a more efficient lottery ticket purchasing process. Information relevant to the lottery ticket purchase is electronically communicated from the ATM through software designed to communicate this information to a third party central computer. The third party central computer reformats the data as necessary, aggregates the relevant consumer payment data associated with the specific lottery ticket purchase data, and transmits the aggregated information to one or more ATM transaction processors and one or more lottery game servicers.

All lottery game servicer data will be subject to standardization, since data received from lottery game servicers by the 3rd party central computer will consist of multiple file and field layouts and descriptions. Once all data has been received from contracting lottery game servicers, the central computer will translate each lottery game servicer's data into a common, standard format that are have been adopted by the ATM transactions processing industries. Once converted, standardized records files will be appended. Standardized records will be available to ATM transaction processors either in batch transmittal or on-line mode during consumer ATM transactions. Batch transmittal will require the processor to temporarily store (i.e., update daily) lottery game servicer records internally in database format either as a part of or separate from other consumer depository account records. Processors not wishing to store lottery game servicer records on-site will be able to access the central computer via standard communications paths, such as a dial-up modem connection, lease line, or TCP (Transmission Communication Protocol)/IP (Internet Protocol), during any on-line consumer ATM transaction. Either access method will provide the ATM transaction processor access to the consumer's lottery game or debt payment obligations during any consumer-initiated ATM transaction, thereby allowing the processor to facilitate the consumer's payment request or to prompt the consumer to make a debt payment based upon dictated transaction precedence logic.

In accordance with the present invention, an ATM banking institution modifies existing ATM screens to allow for lottery ticket purchases, but is otherwise not involved in the process of allowing the consumer to access the lottery ticket purchase process nor in restricting the institutions whose obligations would be paid through the ATM network. In addition, the present invention fully incorporates electronic funds transfers through EFT and ACH networks, thus offering lottery game servicers and payment processors opportunities for significant improvements in processing efficiency.

Most ATMs do not currently permit customers to pay bills, make debt payments or conduct other complex financial transactions, but instead typically limit the user to withdrawals, account inquiries, account transfers, and, if the ATM the user accesses is that of his own bank, deposits. There are some circumstances where ATMs have been used to conduct transactions, such as bill and loan payment transactions. These are described in U.S. Pat. No. 6,304,860.

### PRIOR ART

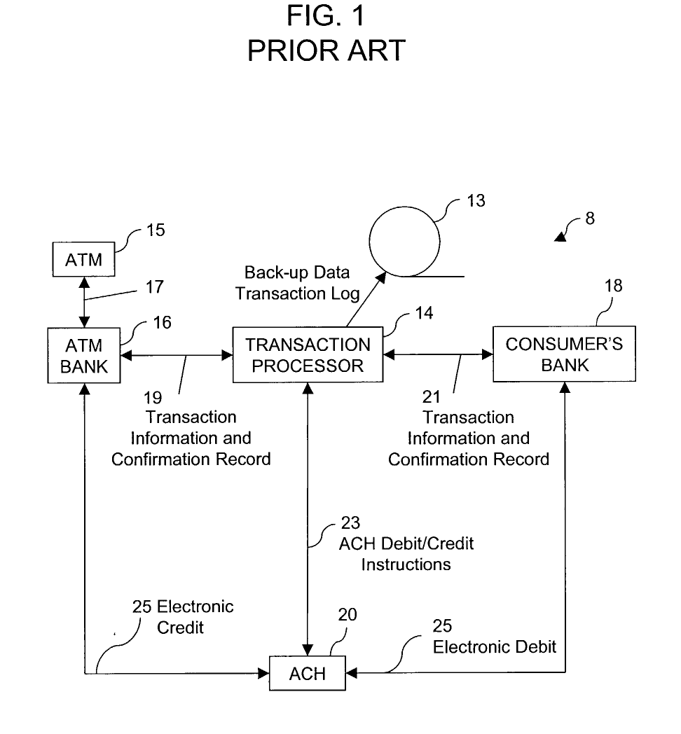

FIG. 1 illustrates a block diagram of an existing prior art system used to process a typical ATM transaction, such as a cash withdrawal or balance inquiry, shown generally at 8. As seen in FIG. 1, the ATM transaction system includes an ATM transaction processor 14, an ATM network access device (such as an ATM terminal) 15, an ATM banking institution 16, a consumer banking institution 18 (where the ATM banking institution 16 and the consumer banking institution 18 can be one and the same), and an automated clearing house (ACH) network 20. ATM network access device 15 is connected to ATM banking institution 16 through a suitable communications path 17. ATM transaction processor 14 is connected with a host computer at ATM banking institution 16 through communications path 19, with a host computer at consumer banking institution 18 through communications path 21, and with ACH network 20 through communications path 23. As is known to those of skill in the art, appropriate information is exchanged between ATM transaction processor 14, ATM banking institution 16, consumer banking institution 18, and ACH network 20 to effect an ATM transaction.

ATM network access device 15 may be physically co-located with the ATM banking institution 16, or may be remotely located with respect thereto. In operation, ATM network access device 15 serves as an interface between a user and the ATM network to receive input from the user and to provide necessary output (and funds, when necessary) to the user. ATM network access device 15 retrieves user information from an ATM card inserted by a user to initiate an ATM transaction, and receives appropriate associated PIN information and transaction information from the user. This information is passed through communication path 17 to the ATM banking institution 16. As necessary, information is then transferred through communications path 19 to ATM transaction processor 14. ATM transaction processor 14 identifies the consumer banking institution 18 from the information retrieved from the user's ATM card, and passes the necessary transaction information entered by the user to the appropriate consumer banking institution 18 through communications path 21.

Consumer banking institution 18 verifies the user's account data and verifies that the user has sufficient funds available for the requested transaction. Consumer banking institution 18 then forwards an authorization message (either a deny transaction request message or a proceed with transaction message, for example) to the ATM transaction processor 14 through communications path 21. ATM transaction processor 14 then forwards the authorization message back to the ATM banking institution 16 through communications path 19. These messages serve to confirm that the transaction is to proceed or be prohibited. Upon receipt of the authorization message, the ATM banking institution 16 forwards the authorization to the ATM network access device 15 using communications path 17. Based on the authorization received, the ATM network access device 15 provides suitable information and funds, if requested, to the user. The user then has the option of terminating the session, or initiating another transaction, which would proceed in a similar fashion.

Once the consumer has terminated the ATM banking session, the ATM transaction processor 14 forwards a confirmation record of the completed transaction to the ATM banking institution 16 using communications path 19, and forwards an identical confirmation record to the consumer's banking institution 18 using communications path 21. ATM transaction processor 14 also forwards a record of the transaction and information to facilitate the appropriate debiting and crediting of the necessary accounts to a designated ACH network 20 through communications path 23. ACH network 20 then operates to debit (where the user has requested a withdrawal of funds, for example) the user's account at the consumer banking institution 18 using communications path 25, and to issue a credit to the ATM banking institution 16 using communications path 27. Finally, ATM transaction processor 14 creates a record of the transaction and writes that record to a back-up data and transactions log 13 for any future reference, if necessary.

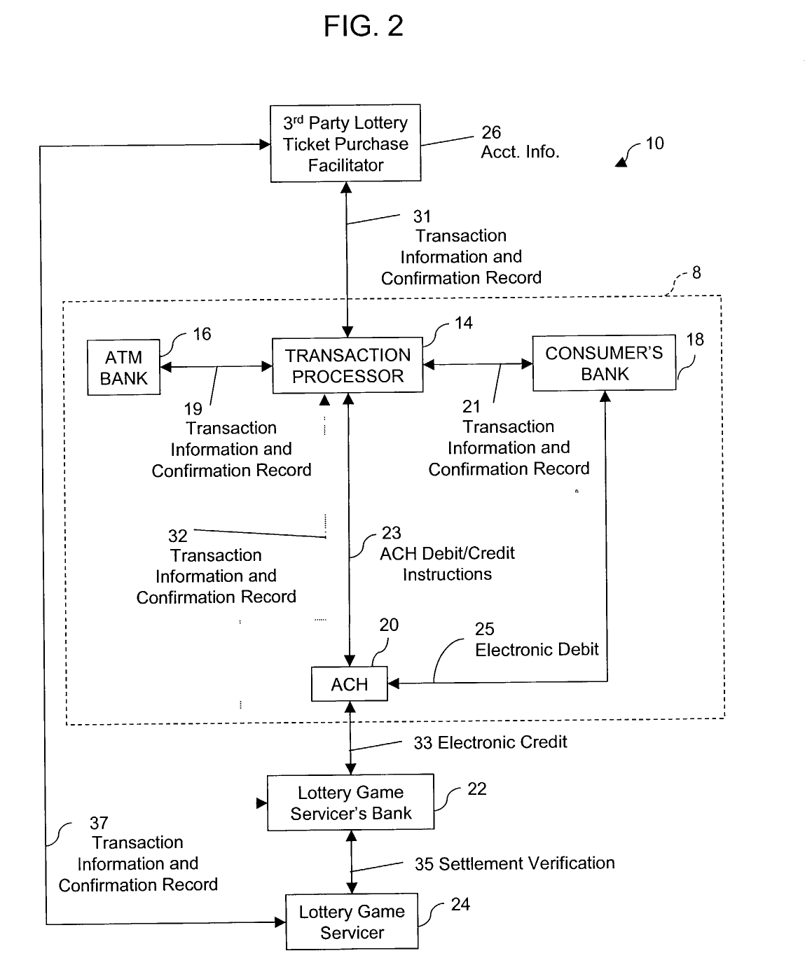

Referring now to FIG. 2, a block diagram illustrating the overall organizational structure of a system for automated lottery ticket purchases in accordance with the present invention is shown generally at 10. As seen in FIG. 2, the lottery ticket purchase system of the present invention includes ATM network 8 shown in more detail in FIG. 1, together with a lottery game servicer's bank 22, a lottery game servicer 24, and a 3rd party lottery ticket purchase facilitator 26. As described above in connection with FIG. 1, ATM network 8 includes an ATM transaction processor 14, an ATM banking institution 16, a consumer banking institution 18, and an ACH network 20.

In order to clarify the operation of the present invention, ATM network access device 15, communications path 17, back-up data and transactions log 13, and communications path 27 are omitted from ATM network 8 as shown in FIG. 2, but these components would typically remain present to handle typical known ATM transactions as described in connection with FIG. 1 above.

3rd party lottery ticket purchase facilitator 26 is connected with ATM transaction processor 14 of the ATM network 8 through communications path 31. Furthermore, the lottery game servicer's bank may be connected with ATM transaction processor 14 of the ATM network 8 through communications path 32. While this connection is not required, it can be used to provide communication of transaction information and confirmation records between transaction processor 14 and the lottery game servicer's bank 22.

The lottery game servicer's bank 22 is connected with ACH network 20 through communications means 33 and is connected to the lottery game servicer 24 through a suitable communications medium 35, which be any of an electronic, telephonic, or postal interconnection. 3rd party lottery ticket purchase facilitator 26 and lottery game servicer 24 are also connected with each other through communications path 37.

In accordance with the present invention, 3rd party lottery ticket purchase facilitator 26 and the lottery game servicer 24 cooperate with each other and with the ATM network 8 to allow a consumer to purchase a lottery ticket using the ATM network 8. 3rd party lottery ticket purchase facilitator 26 makes lottery ticket purchase data available to the ATM network 8 through communications path 31. This information may be uploaded to transaction processor 14 in a bulk transfer on a periodic basis, such as once a day, or may be supplied to transaction processor 14 on a transaction-by-transaction basis. In a case where a bulk transfer is used, communications path 31 may be an intermittent link, such as a dial-up modem connection, that is periodically established when it is necessary to transfer data to transaction processor 14. Conversely, when a transaction-by-transaction transfer is used, communications path 31 must be substantially permanent since transaction processor 14 will request such information any time a consumer initiates an ATM transaction.

Communications path 31 is also used to transfer information from transaction processor 14 to 3rd party lottery ticket purchase facilitator 26. For example, 3rd party lottery ticket purchase facilitator 26 will receive information from transaction processor 14 indicating that a user has completed a purchase of a lottery ticket. In this manner, the records maintained by the 3rd party lottery ticket purchase facilitator can be updated, if desired, to reflect that such purchase has been made. As described in more detail below, this information is also communicated to lottery game servicer 24 to assist, among other things, with updating lottery records and with the settlement verification process occurring between lottery game servicer 24 and the lottery game servicer's bank 22.

3rd party lottery ticket purchase facilitator 26 and lottery game servicer 24 are connected and communicate through a communications path 37, which may be any suitable data communications path, such as a dial-up modem connection, leased line, or TCP/IP connection. 3rd party lottery ticket purchase facilitator 26 receives lottery game information from lottery game servicer 24. While a single communications path 37 and a single lottery game servicer 24 are shown in FIG. 2 for clarity, in practice the present invention will likely include any number of lottery game servicers and associated communications paths 37 connected therewith. In such case, 3rd party lottery ticket purchase facilitator 26 will collect lottery game information from each of the plurality of lottery game servicers 24 through the communications paths 37 and will process this information as discussed in detail below to generate suitable transaction information for transfer to transaction processor 14 through communications path 31.

As mentioned above, lottery game servicer 24 also receives purchase transaction records from the 3rd party lottery ticket purchase facilitator 26 through communications path 37. In this manner, lottery game servicer 24 is notified that a purchase has been made and that it can expect to receive a verification of such purchase from the lottery game servicer's bank 22 in due course.

In a manner similar to the ATM banking institution shown in FIG. 1, the lottery game servicer's bank 22 is connected with the ACH network 20 of the ATM network 8 and receives electronic purchase credits from the ACH network 20 through communications means 33.

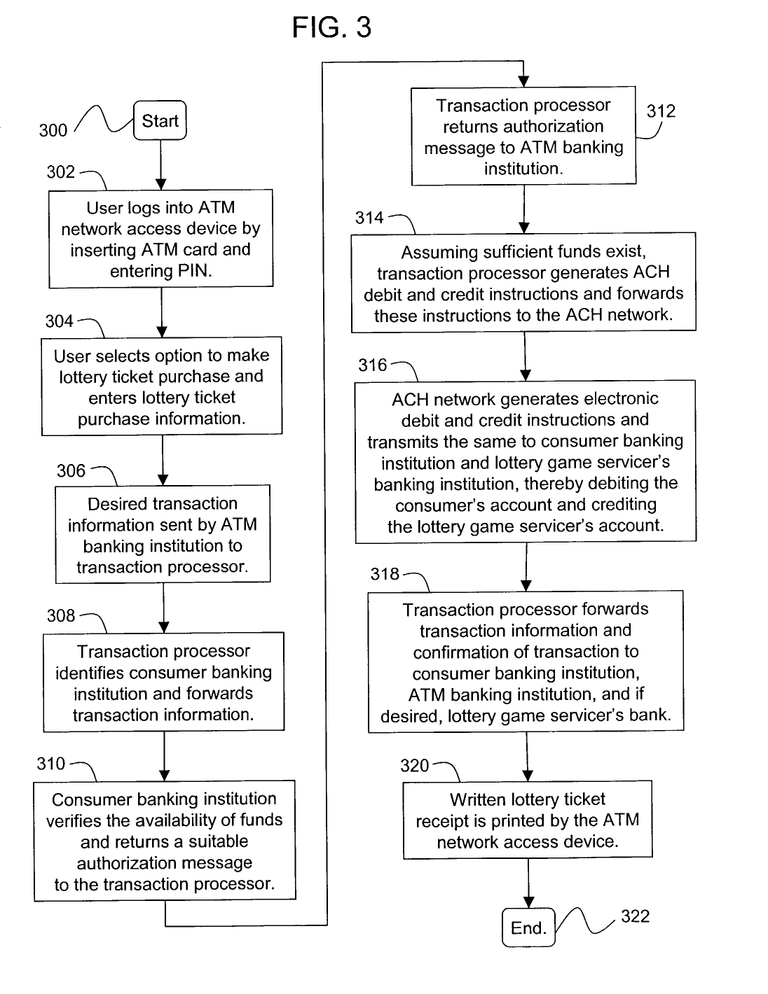

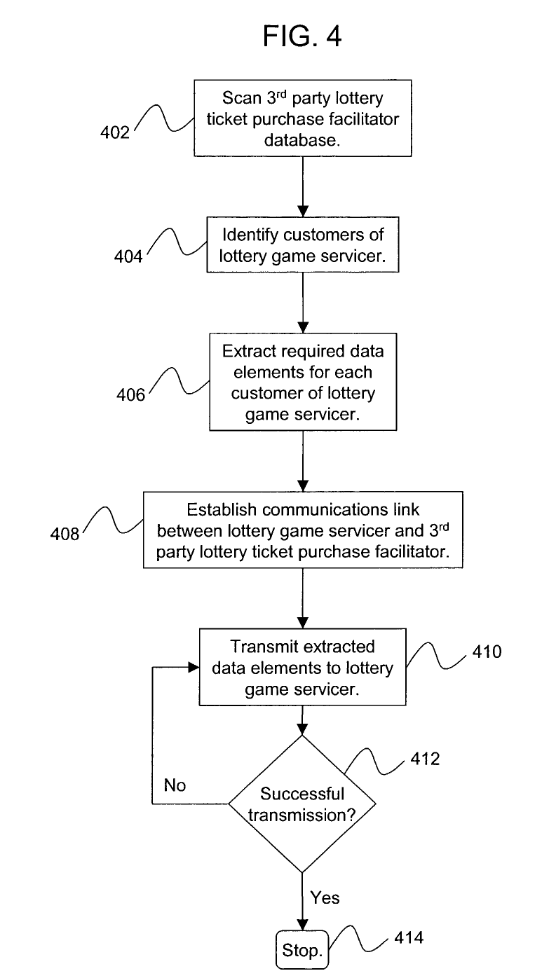

The process followed by a consumer to purchase a lottery ticket will now be described in more detail in connection with FIG. 3. The lottery ticket purchase process shown in FIG. 3 illustrates the transactions performed by the ATM network 8 (FIGS. 1 and 2) in response to a user request that a lottery ticket be purchased, and funds transferred from the consumer's banking institution 18 to a lottery game servicer's bank 22. FIG. 3 does not illustrate the process by which information about a consumer's lottery ticket purchase is retrieved from the lottery ticket purchase facilitator 26 and made available to the ATM network 8 to facilitate the purchase and the printing of the lottery ticket. These features of the present invention are discussed in more detail below in connection with FIGS. 4-7.

Referring now to FIGS. 2 and 3, the process starts in block 300. In block 302 a user initiates an ATM session by inserting his ATM card and entering an appropriate PIN into an ATM network access device, such as an ATM terminal. Once the user has successfully logged into the ATM network, the user may elect to make a lottery ticket purchase in block 304. The user will be prompted to identify the lottery game for which he wishes to purchase a ticket, and enter the require lottery ticket purchase information. It should be noted that the user is not obligated to provide detailed information to identify the lotter game and other specific lottery ticket purchase information (e.g. lottery numbers to be played), but rather the user is provided with a series of display prompts that the user can select to make a lottery ticket purchase.

Once the user has indicated the lottery game and other lottery ticket purchase information (e.g. lottery numbers to be played) in block 304, the appropriate transaction information is sent from the ATM banking institution 16 to a suitable transaction processor 14 in block 306. In block 308, the transaction processor receives this information, identifies the appropriate consumer banking institution 18 associated with the user, and forwards appropriate transaction information to the consumer's banking institution 18.

The consumer's banking institution 18 uses this information to verify that sufficient funds are available in the user's account to satisfy the requested transaction in block 310. The consumer's banking institution 18 then generates an appropriate authorization message and returns it to transaction processor 14. In the event that sufficient funds are present for the transaction, the authorization message will indicate that the transaction should proceed. In the event that insufficient funds are present for the transaction, the authorization message will so indicate and the transaction will be halted with an appropriate message being displayed to the user at the ATM banking institution 16. In either event, transaction processor 14 forwards the authorization message back to the ATM banking institution 16 as shown in block 312.

In block 314, assuming that sufficient funds exist for the transaction to proceed, transaction processor 14 generates appropriate debit and credit instructions and forwards these instructions to the ACH network 20 in order to initiate the actual transfer of funds between the consumer's banking institution 18 and the lottery game servicer's bank 22. Specifically, the transaction processor 14 will request the ACH network to debit the consumer's account at the consumer's banking institution 18 by an amount equal to the purchase amount indicated by the consumer, and will request that a credit be made to the appropriate lottery game servicer's account at the lottery game servicer's bank 22. In block 316, the ACH network will receive these fund transfer requests from the transaction processor and will generate and forward suitable debit and credit transaction requests to the appropriate banking institutions.

In block 318, the transaction processor 14 will generate suitable confirmations that the transaction has been completed and will forward confirmation records of such completion to the consumer's banking institution 18, to the ATM banking institution 16, and to the 3rd party lottery ticket purchase facilitator 26. Transaction processor 14 can also forward a confirmation record of such completion to the lottery game servicer's bank 22 using optional communications path 32 as desired. With confirmation that the transaction has been successfully completed and a notice to that effect is displayed to the consumer.

In block 320, the ATM network access device prints a written lottery ticket, and the process ends in block 322. The above lottery ticket purchase transaction process described in connection with FIG. 3 assumes that lottery ticket purchase information is available to the ATM network 8 for use in processing a consumer's request for a lottery ticket purchase transaction. However, the currently known ATM system does not include such information and it is an object of the present invention to provide a system and method for making this information available to the ATM network 8 to facilitate the purchase of lottery tickets in the manner described above in connection with FIG. 3.

In accordance with the present invention, means are provided with both the 3rd party lottery ticket purchase facilitator 26 and the lottery game servicer 24 to obtain the necessary information for use by the ATM network 8 in processing a consumer's lottery ticket purchase request. In the most preferred embodiment, these means include software operating on a suitable computing device at both the 3rd party lottery ticket purchase facilitator's 26 location and at the lottery game servicer's 24 location. This software operates to provide communication between the 3rd party lottery ticket purchase facilitator 26 and the lottery game servicer 24, as well as appropriate communication with ATM network 8 using communications paths 31 and 37 shown in FIG. 2.

The software residing at the lottery game servicer's 24 location interfaces with communication path 37 to transfer information between lottery game servicer 24 and 3rd party lottery ticket purchase facilitator 26. During installation of this software, various information is input by the lottery game servicer 24 to facilitate this communication, including identification of the lottery game servicer's 24 type of modem and dial-in number for modem communications, operating environment, database design, systems platform, and contact information at the lottery game servicer's 24 place of business, etc.

As illustrated in FIG. 4 in block 400, the software scans the database of the 3^{rd} party lottery ticket purchase facilitator 26 and in block 402 identifies customers who have purchased a lottery ticket using the services of 3rd party lottery ticket purchase facilitator 26. When a customer is located, the software extracts the necessary data elements from the record and preferably stores this information in a temporary file in block 404. The scanning process then continues in this manner until it has completed scanning the entire database of the 3^{rd} party lottery ticket purchase facilitator 26. In accordance with the most preferred embodiment of the present invention, the extracting software is executed at least once each day between 4 and 6 pm U.S. Eastern Standard Time. The software should automatically initiate and complete the database scanning process based on time parameters provided by lottery game servicer 24. Where automatic execution is not possible, the software prompts a user as a reminder that the database scan needs to be executed and informs the user as to how long it has been since the last update was processed.

Once the appropriate data elements are extracted from lottery ticket purchase facilitator's 26 database, the software establishes in block 406 a communications link between the lottery game servicer 24 and the 3rd party lottery ticket purchase facilitator 26 and transmits this data to the lottery game servicer 24 in block 408. While in this embodiment communications are initiated by the3d party lottery ticket purchase facilitator 26, it will be apparent to those of skill in the art that it is possible, and in fact may be preferable, for lottery ticket servicer 24 to initiate data communications with the 3^{rd} party lottery ticket purchase facilitator 26. Any suitable communications path can be used, including a dial-up modem connection, leased line, TCP/IP or world wide computer network interconnection. In block 410, the software verifies that the data has been accurately transmitted and retries the transmission if a failure occurs. Upon successful transmission, the process ends in block 412.

As noted above, the system and method of the present invention will likely interact with any number of lottery game servicers, or with geographically dispersed operations centers of large lottery game servicers. Therefore, the above data extraction process is performed for any and all lottery game servicers or operations centers having information that must be communicated to the 3rd party lottery ticket purchase facilitator 26.

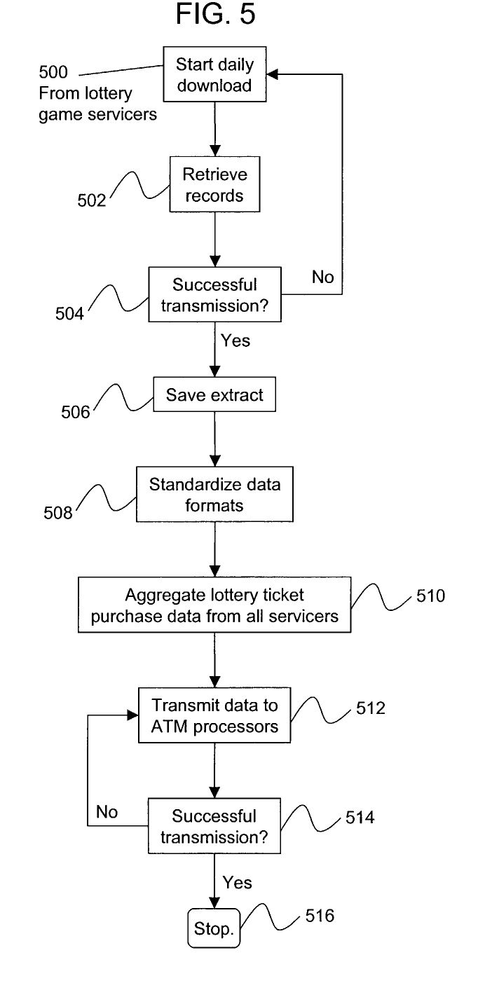

The data from each of the lottery game servicers 24 is received by 3rd party lottery ticket purchase facilitator 26 using appropriate communications and processing software, which is illustrated in flow chart form in FIG. 5. This software is capable of receiving data from a plurality of lottery game servicers or operations centers. A log of records received from each lottery game servicer is also generated and stored with the 3rd party lottery ticket purchase facilitator 26. As seen in FIG. 5, the process begins with the initiation of a daily download in block 500. The software retrieves from the lottery game servicer 24 the required data elements extracted from the lottery game servicer's records (FIG. 4, block 404) in block 502. If the transmission fails in block 504, control returns to block 500 and the download session is repeated. Upon a successful transmission, the extracted data is saved in block 506 and converted to an appropriate format in block 508 for storage in a database at the 3rd party lottery ticket purchase facilitator's 26 location. The data may also be saved to a back-up log for subsequent recovery or verification purposes. The data formatting used by each of the lottery game servicers 24 may or may not correspond to each other and to the format used by 3rd party lottery ticket purchase facilitator 26. Therefore, when an incompatible data format is used, the 3rd party lottery ticket purchase facilitator 26 first converts the information into a format compatible with the 3^{rd} party lottery ticket purchase facilitator's 26 database system.

Once the software receives, converts and stores data from all lottery game servicers 24 or from all operations centers of geographically dispersed lottery game servicers, the data is converted and aggregated into a suitable format for communication to ATM network 8 (FIG. 2) as shown in block 510. While the above process is the preferred method in accordance with the present invention of receiving and processing the debt related information, it is to be understood by those of skill in the art that the data retrieval, formatting, and storage can be modified as desired. The primary objective achieved by the present invention is the retrieval of information of one or more lottery game servicers and the conversion of this information into a form that can be readily processed by an ATM transaction network to permit a user of the ATM network to view this data or to initiate a transaction in response to this data.

This data is then communicated in block 512 to ATM network 8 through a communication path 31, for example. In accordance with the present invention, the totality of this data can be downloaded to transaction processor 14 so that it is readily available when a consumer initiates a lottery ticket purchase transaction using ATM network 8, or it may be stored in a database at the 3rd party lottery ticket purchase facilitator's 26 location and single data records can be transferred to the ATM network 8 as required in response to a request from the transaction processor 14. This data is then used by the transaction processor 14 in the fashion described above in connection with FIGS. 2 and 3 to process lottery ticket purchase requests initiated by a consumer. If the data is found to be successfully transmitted to the transaction processor 14 in block 514, the process terminates in block 516. If a transmission error is determined in block 514, then the process returns to block 512 and the data is retransmitted to the ATM processors until a successful transmission is achieved.

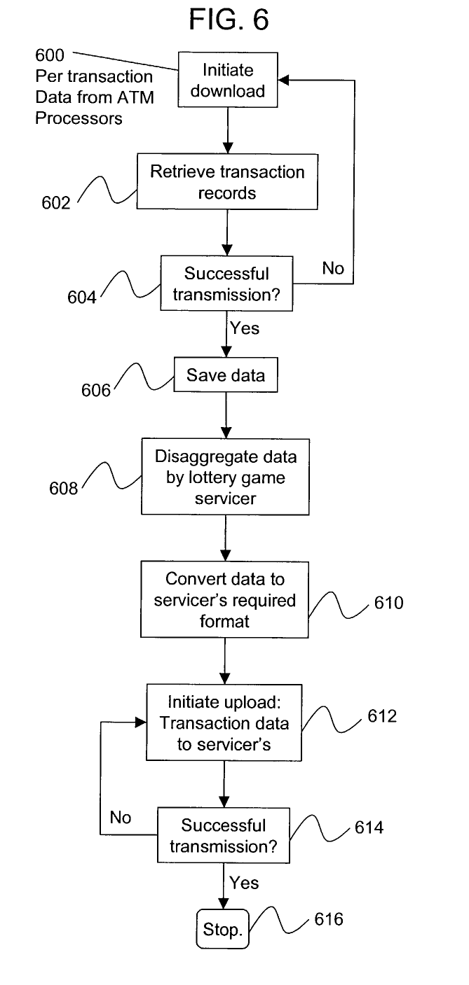

The 3rd party lottery ticket purchase facilitator 26 software further operates to receive a record of each lottery ticket purchase transaction processed by the transaction processor 14, either on a transaction-by-transaction basis or in bulk form at the end of each business day. A flowchart of this portion of the software is shown in FIG. 6. The process begins in block 600 with the initiation of a download process. The software receives information for all successfully completed transactions in block 602.

If the transmission fails in block 604, the process returns to block 600, where the download procedure is retried. Upon successful transmission of the data, the process proceeds to block 606, where the downloaded data is saved. In block 608, the transaction records are disaggregated by lottery game servicer. From this information, detailed records of the amount of funds transferred for each ticket purchased are received and this information can be compared with the records received from the lottery game servicer 24 and appropriate entries made to indicate that certain lottery tickets have been purchased.

Next, in block 610, the 3rd party lottery ticket purchase facilitator 26 software formats this information into a suitable form and forwards, in block 612, suitable information to the lottery game servicers 24 sufficient to identify the transactions completed for the given reporting period. In the event that no transactions have been processed for a particular lottery game servicer 24, this information is also forwarded to the lottery game servicer 24 to confirm that no transactions in fact occurred. If the transmission is found to be successful in block 614, then the process ends in block 616. Otherwise, control returns to block 612, where the transmission to the lottery game servicers 24 is retried.

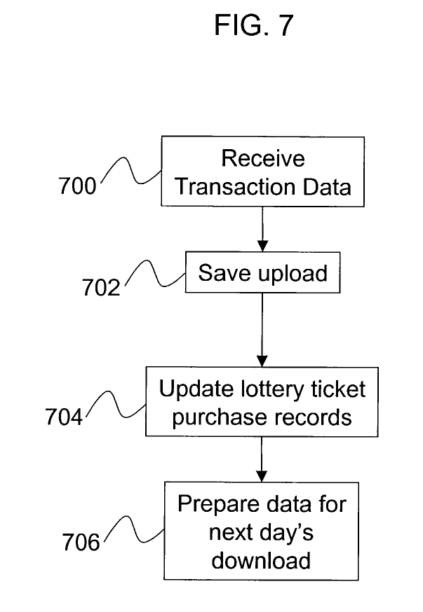

Referring to FIG. 7, upon receipt of this information in block 700, lottery game servicer 24 will save the information in block 702 and update its records in block 704 to reflect the purchases processed by the ATM network 8, and will further use this information to aid in the settlement verification process and reconciliation of its bank accounts with lottery game servicer's bank 22. Furthermore, with this timely data, the lottery game servicers 24 can generate any necessary reports of transactions for forwarding to investors or secondary market agencies as required. Lottery game servicer 24 will then prepare the data for download the following day to the 3rd party lottery ticket purchase facilitator in block 706.

In accordance with the present invention, appropriate modifications are made to the ATM network 8, and specifically to the ATM network access device, or ATM terminal, 15 shown in FIG. 1. A consumer electing to make a lottery ticket purchase through an ATM selects an appropriate option from the ATM functional menu, after first having passed through the standard access requirements (i.e., inserting a magnetic-stripe ATM/debit card and entering an associated PIN). Once access has been gained, the consumer selects a lottery ticket purchase option from the ATM functional menu, and completes the transaction by responding to a series of prompts displayed on the ATM screens. If adequate funds are available in the consumer's transaction account to cover the amount of the purchase, the consumer is given a receipt evidencing the transaction provided to the consumer in the form of a written lottery ticket printed by the ATM network access device, and is returned to the ATM's main display screen for additional transactions. If sufficient funds are not available for the purchase, the consumer is advised of the condition, the payment transaction is terminated, and the consumer is returned to the ATM's main display screen for additional transactions.

Although the invention has been described with reference to specific embodiments, various modifications of the disclosed embodiments as well as other embodiments of the invention will become apparent to persons skilled in the art on reference to the detailed description of the invention contained herein. Accordingly, the claims of the present application should not be limited to the specific preferred embodiments described

1. A method of processing lottery ticket purchases using an automatic teller machine and associated automatic teller machine networks to communicate user inserted information to a teller machine for transmission to a transaction processor. For transmission to a user bank and an automatic teller machine bank including the steps of:
a) providing a third party lottery ticket purchase facilitator for obtaining said information;
b) providing a lottery game servicer having banking facilities;
c) communicating user information through said transaction processor to said user bank and said lottery game servicer banking facility;
d) employing said inserted information upon approval of said user bank to actuate said automated teller machine to print and dispense a requested lottery ticket.

2. The method set forth in claim 1, including the further step of confirming a completed purchase transaction between said lottery game servicer banking facility and said user bank.

3. A system for vending lottery tickets to a user comprising: an automatic teller machine having means for presenting and delivering a receipt; a transaction processor; an automatic teller machine bank and a user bank communicating with said transaction processor for completing a user initiated transaction; a third party lottery ticket purchase facilitator communicating with said transaction processor for receiving purchase information from said user; a lottery game servicer having banking facilities communicating with said ticket purchase facilitator; said transaction processor being selectively activated to communicate with said lottery ticket purchase facilitator upon receipt of user inserted purchase information from said user; said user bank selectively issuing command data for operating said printing means to print and dispense a lottery ticket.
